(19) United States
(12) Patent Application Publication
(10) Pub. No.: US 2015/0032744 A1
(43) Pub. Date: Jan. 29, 2015

(54) GENERATION OF PERSONALIZED PLAYLISTS FOR REPRODUCING CONTENTS

(71) Applicant: Orange, Paris (FR)

(72) Inventors: Stephane Roulliere, Rennes (FR); Tristan Heau, Bazoches-au-Houlme (FR); Nicolas Doisy, Rennes (FR)

(21) Appl. No.: 14/445,758

(22) Filed: Jul. 29, 2014

(30) Foreign Application Priority Data
Jul. 29, 2013 (FR) 1357471

(51) Int. Cl. G06F 17/30

(52) U.S. Cl. CPC G06F 17/30053
USPC 707/736

(57) ABSTRACT

A method is provided for generating personalized playlists for reproducing contents in relation to the experience of an event by a user of a communication terminal. The method includes determining at least two distinct elements as a function of data provided by the communication terminal of the user and of data relating to the event which are made available by a device for providing services concerning the event. Each of the elements makes it possible to determine at least one content made available by at least one device for providing contents, wherein the contents thus determined for each element are integrated into a playlist. Thus, the playlist is not only generated automatically but in addition it is associated with an event and personalized as a function of the experience of this event by a user.

### FIELD OF THE DISCLOSURE

The invention pertains to the automatic generation of playlists for reproducing contents.

### BACKGROUND OF THE DISCLOSURE

Today, providers of content, particularly of audio content, allow their users to create playlists manually. Thus, a user will be able subsequently to listen or enable others to listen (particularly by sharing his playlist) to contents that he has selected in the order that he has indicated or in some other order (random, sorted by name of artist, genre, name of tracks, albums, etc.). The users of these content provision services can also access playlists made available or shared by the content provision service or other users of the provision service (private but also professional such as radio operators, television broadcasts, etc.).

On the other hand, with the broadening of event-based offerings, people are attending more and more artistic events: music festivals, theater, movies, etc. Now, in order to re-experience such events, the participants at such events will either have complete content such as a DVD of the festival or its video-on-demand equivalent, or the participant will have to search for the references of the works or artists a posteriori in order to search for and optionally consume contents relating to the latter.

### SUMMARY

A subject of the invention is a method of generating personalized playlists for reproducing contents in relation to the experience of an event by a user of a communication terminal, said playlist generating method comprising a determination of at least two distinct elements as a function of data provided by said communication terminal of said user and of data relating to said event which are made available by a device for providing services concerning said event, each of said elements making it possible to determine at least one content made available by at least one device for providing contents, said contents thus determined for each element being integrated into a playlist.

Thus, the playlist is not only generated automatically but in addition it is associated with an event and personalized as a function of the experience of this event by a user.

Advantageously, the method of generating playlists comprises an integration into said personalized playlist relating to the experience of an event by a user of at least one content made available by a device for providing contents, said at least one content being determined as a function of said element.

Thus, the contents are loaded automatically into the playlist without particular action by the user.

Advantageously, the method of generating playlists comprises a recovering of geolocation data constituting at least one datum provided by said communication terminal of said user.

Thus, the experience of the event is determined as a function of the user's movements during this event.

Advantageously, the method of generating playlists comprises a recovering of multimedia data captured by said communication terminal constituting at least one datum provided by said communication terminal of said user.

Thus, the experience of the event is determined as a function of data captured (audio and/or video) during the event by the communication terminal of the user, whether or not the captured data are recorded locally or remotely in the network.

Advantageously, the method of generating playlists comprises a triggering of said determination of an element on action of said user on said communication terminal.

Thus, an element making it possible to determine at least one contents of the playlist relating to the event is determined only if the user performs an action relating to the event, particularly indication of favorites (known as “lie”) to a services provision device relating to the event such as on the page of a social network relating to the event.

Advantageously, the data de relating to said event that are made available by a device for providing services concerning said event are data generated in real time by said device for providing services as a function of a recognition of captured multimedia data received by said device for providing services.

Thus, the determination of the element will be done on the basis of more precise data relating to the event and taking account of a possible last minute change of programming. Captured multimedia data such as a photo of a solo artist not corresponding to the artist originally programmed on this stage makes it possible to provide the name of the artist actually on stage in the data de relating to the event so as to determine an element making it possible to integrate into the personalized playlist tracks by this artist whose concert the user has attended and not by the artist originally programmed on this stage but that the user has not seen.

The invention is therefore also aimed at a program comprising program code instructions for the execution of the steps of the method of generating playlists when said program is executed by a processor.

This program can use any programming language and be in the form of source code, object code or code intermediate between source code and object code such as in a partially compiled form or in any other desirable form.

Advantageously, according to a deployment of the invention, the various steps of the method according to the invention are implemented by software or computer program, this software comprising software instructions intended to be executed by a data processor of a generator of playlists and being designed to control the execution of the various steps of this method.

Another subject of the invention is a generator of personalized playlists for reproducing contents in relation to the experience of an event by a user of a communication terminal, said generator of playlists comprising an analyzer able to determine at least two distinct elements as a function of data provided by said communication terminal of said user and of data relating to said event which are made available by a device for providing services concerning said event, each of said elements making it possible to determine at least one content made available by at least one device for providing contents, said contents thus determined for each element being integrated into a playlist.

A subject of the invention is also a device for providing contents comprising a database of contents and a generator of playlists for reproducing contents, said generator of playlists comprising an analyzer able to determine at least two distinct elements as a function of data provided by a communication terminal of a user and of data relating to an event experienced by said user and which are made available by a device for providing services concerning said event, each of said elements making it possible to determine at least one content made available by said device for providing contents, said contents thus determined for each element being integrated into a playlist.

A subject of the invention is furthermore a services provision device relating to an event making available to a generator of personalized playlists for reproducing contents in relation to the experience of an event by a user of a communication terminal, data relating to said event, as a function of which contents and of data provided by said terminal of said user, the generator of playlists determines an element making it possible to determine at least one content made available by at least one device for providing contents.

Advantageously, the device for providing services comprises a real-time generator of data relating to said event as a function of captured multimedia data received by the device for providing services.

Thus, the determination of the element will be made on the basis of more precise data relating to the event and taking account of a possible last minute change of programming. Captured multimedia data such as a photo of a solo artist not corresponding to the artist originally programmed on this stage makes it possible to provide the name of the artist actually on stage in the data de relating to the event so as to determine an element making it possible to integrate into the personalized playlist tracks by this artist whose concert the user has attended and not by the artist originally programmed on this stage but that the user has not seen.

A subject of the invention is also a method of user interface with a generator of personalized playlists for reproducing contents in relation to the experience of an event by a user of a communication terminal, said method of user interface with a generator of playlists comprising a transmission of data by said communication terminal from said user to a generator of playlists, said transmitted data making it possible to determine an element as a function of said data transmitted by said communication terminal of said user and of data relating to said event which are made available by a device for providing services concerning said event, said element making it possible to determine at least one content made available by at least one device for providing contents.

Advantageously, according to a deployment of the invention, the various steps of the method according to the invention are implemented by software or computer program, this software comprising software instructions intended to be executed by a data processor of a device forming part of a communication terminal and being designed to control the execution of the various steps of this method.

The invention is therefore also aimed at a program comprising program code instructions for the execution of the steps of the method of user interface with a generator of playlists when said program is executed by a processor.

This program can use any programming language and be in the form of source code, object code or code intermediate between source code and object code such as in a partially compiled form or in any other desirable form.

A subject of the invention is furthermore a user interface with a generator of personalized playlists for reproducing contents in relation to the experience of an event by a user of a communication terminal, said user interface with a generator of playlists comprising a trigger for transmission of data by said communication terminal from said user to a generator of playlists, said transmitted data making it possible to determine an element as a function of said data transmitted by said communication terminal of said user and of data relating to said event which are made available by a device for providing services concerning said event, said element making it possible to determine at least one content made available by at least one device for providing contents.

Advantageously, the user interface with a generator of playlists comprising at least one access to at least one personalized playlist for reproducing contents in relation to the experience of said event by said user.

A subject of the invention is also a communication terminal of a user comprising at least one user interface with a generator of personalized playlists for reproducing contents in relation to the experience of an event by a user of a communication terminal, said user interface with a generator of playlists comprising a trigger for transmission of data by said communication terminal from said user to a generator of playlists, said transmitted data making it possible to determine an element as a function of said data transmitted by said communication terminal of said user and of data relating to said event which are made available by a device for providing services concerning said event, said element making it possible to determine at least one content made available by at least one device for providing contents.

### BRIEF DESCRIPTION OF THE DRAWINGS

The characteristics and advantages of the invention will be more clearly apparent on reading the description, given by way of example, and the figures relating thereto which represent:

FIG. 1, a simplified diagram of the methods of generating playlists and of user interface according to the invention,

FIG. 2, a simplified diagram of an exemplary architecture comprising a generator of playlists and a user interface with said generator of playlists according to the invention, and

FIGS. 3a and 3b, two simplified diagrams of two examples of variants of implementation of the invention.

### DETAILED DESCRIPTION OF ILLUSTRATIVE EMBODIMENTS

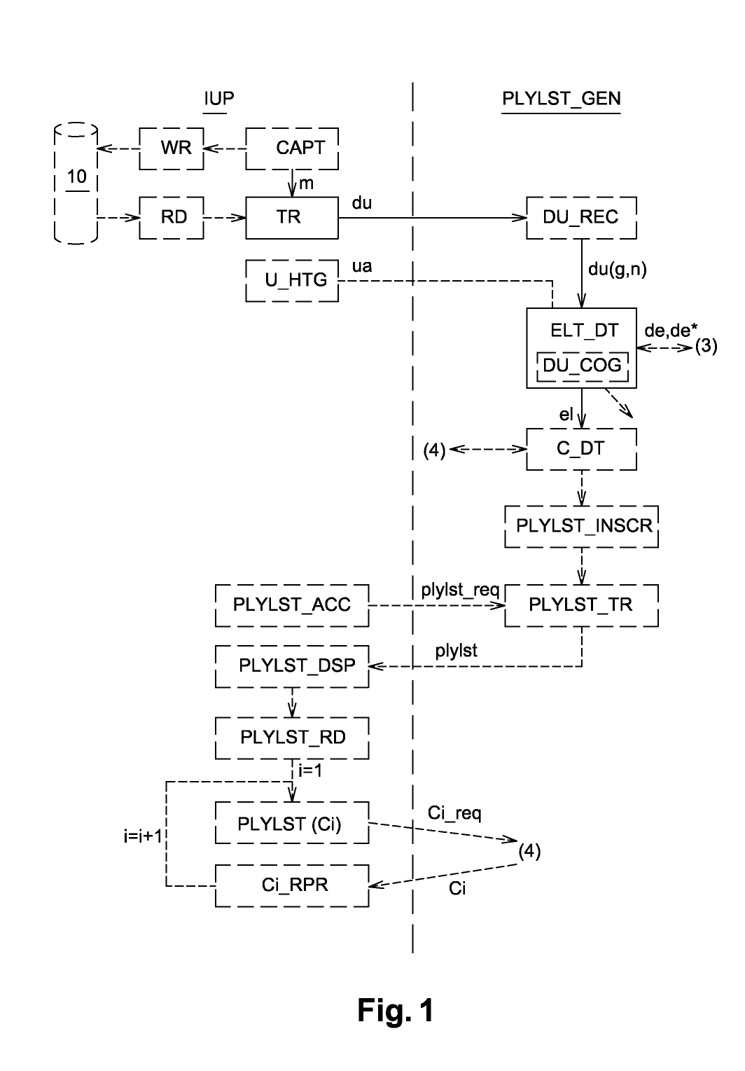

FIG. 1 illustrates a simplified diagram of the methods of generating playlists and of user interface according to the invention.

The method PLYLST_GEN of generating personalized playlists for reproducing contents in relation to the experience of an event by a user of a communication terminal, comprises a determination ELT_DT of an element el as a function of data du provided by said communication terminal of said user and of data relating to said event de which are made available by a device for providing services 3 concerning said event. The element el makes it possible to determine at least one content c made available by at least one device for providing contents 4.

In particular, the data du are provided by a method of user interface IUP implemented by the user's communication terminal.

In particular, the method of generating playlists PLYLST_GEN comprises an integration PLYLST_INSCR into said personalized playlist relating to the experience of an event by a user of at least one content made available by a device for providing contents 4. This content c is determined C_DT as a function of said element el.

In particular, the method of generating playlists PLYLST_GEN comprises a recovering DU_REC of geolocation data g constituting at least one datum du provided by said communication terminal of said user.

In particular, the method of generating playlists PLYLST_GEN comprises a recovering DU_REC of multimedia data m captured by said communication terminal constituting at least one datum du provided by said communication terminal of said user.

In particular, the determination of an element ELT_DT comprises either a recognition or a command of a recognition DU_COG of the multimedia data captured m as a function of the data de relating to the event and optionally of other data du transmitted by the communication terminal such as the location and/or the instant of capture etc. Thus, the recognition on audio and/or video and/or image data will make it possible to recognize at least one of the following elements: the performing artist or artists, the name of the composer and/or of the author, the name of the work (album, book, plays, paintings, sculptures, monuments, etc.) and/or the section of the work (track, chapter, act/scene, hall, etc.).

This recognition DU_COG will be simplified by the knowledge of the data de relating to the event and optionally of other data du transmitted by the communication terminal. Indeed, these data will limit the search to the artists programmed at the event, optionally to the works programmed and/or to the list of the most listened to/seen works of these artists programmed at the event (music festival, dance, theater, exhibitions, etc.).

In particular, the method of generating playlists comprises a triggering of said determination ELT_DT of an element on action ua of said user on said communication terminal.

In particular, the data de relating to the event comprise data stored in a services provision device 3 relating to the event. Optionally, the data de relating to the event comprise data generated in real time by a services provision device 3 relating to the event.

In particular, a method of real-time generation of data relating to the event particularly implemented by the services provision device 3 relating to the event comprises a transmission of real-time data relating to the event allowing a determination of at least two distinct elements by a method of generating playlists, the real-time data transmitted being dependent on a recognition of captured multimedia data received.

In particular, the method of generating playlists comprises a determination C_DT of one or more contents as a function of each of the elements determined el. The determination C_DT of one or more contents is performed as a function of contents made available by one or more devices for providing contents 4.

In particular, the method of generating playlists comprises the integration PLYLST_INSCR of at least one content determined as a function of the element el into the personalized playlist relating to the event. The integration of a content PLYLST_INSCR consists particularly of the integration either of a link to said content in a device for providing contents 3, or of elements el* making it possible to retrieve said content in a device for providing contents 3 (these elements el* are particularly contained in the metadata of the content c determined as a function of the element el).

In particular, the method of generating playlists comprises a transmission of the playlist generated PLYLST_TR to a communication terminal of a user, particularly on request plylst_req of the playlist by said communication terminal.

An embodiment of the method of generating playlists is a program comprising program code instructions for the execution of the steps of the method of generating playlists when said program is executed by a processor.

The method of user interface IUP with a generator of personalized playlists for reproducing contents in relation to the experience of an event by a user of a communication terminal comprises a transmission TR of data du by said communication terminal from said user to a generator of playlists. The data du transmitted make it possible to determine an element el as a function of said data transmitted by said communication terminal of said user and of data de relating to said event which are made available by a device for providing services 3 concerning said event. The element el makes it possible to determine at least one content c made available by at least one device for providing contents 4.

An embodiment of the method of user interface is a program comprising program code instructions for the execution of the steps of the method of user interface with a generator of playlists when said program is executed by a processor.

In particular, the method of user interface IUP comprises a capture CAPT, particularly an audio and/or video capture. The captured data m can be transmitted TR directly. The captured data m are optionally recorded WR in storage means 10 of the user's communication terminal. The method of user interface IUP optionally comprises this recording WR of the captured data m.

In an alternative manner to the direct transmission of the captured data m, the method of user interface IUP transmits TR the recorded captured data m either immediately after their recording WR, or subsequently upon, for example, a request to create playlists by the user. The method of user interface then comprises particularly a reading RD of the data captured m, during the event for which a playlist is currently undergoing generation, and recorded WR. The reading is in particular done in the storage means 10.

In particular, the method of user interface IUP transmits TR, jointly and/or independently of the captured data m, other data concerning the user during the event, particularly the instant of capture t of the captured data m and/or the location g of the communication terminal during the capture CAPT of the captured data m, etc.

In particular, the method of user interface comprises a user command U_HGT allowing the user of the communication terminal to act in relation to the event in progress. The user command U_HGT is particularly a make-a-favorite command (called a “like”) relating to the event comprising for example the instant and the location of the communication terminal during the make-a-favorite command.

The action of the user ua is transmitted to the method of generating playlists PLYLST_GEN: the action ua is then, particularly, at the origin of a triggering of the determination of at least two distinct elements ELT_DT. Thus, the invention will make it possible to add to the playlist only those contents relating to the instants of the event experienced by the user that the user has indicated they like.

In an alternative manner, the invention will make it possible to add to the playlist more contents relating to the instants of the event experienced by the user that the user has indicated they like than contents relating to the instants of the event experienced by the user, but for which the user has indicated nothing. The user command U_HGT provides an action ua making it possible not only to trigger the element determination ELT_DT but optionally to control the generation of playlists PLYLST_GEN, particularly the content determination C_DT, so as to determine a number of predetermined tagged contents which relate to the element el whose determination EL_DT has been commanded U_HGT by the user instead of the number of contents by default.

In the case of a music festival, instead of determining only one track (if 1 is the number of contents by default) relating to an artist listened to by the user during the festival so as to include it in the personalized playlist relating to the music festival, the indication of favorite by the user will trigger the determination of five tracks (if 5 is the predetermined number of contents tagged) relating to the artist listened to by the user during the user command U_HGT which will be included in the personalized playlist relating to the music festival.

For example, the number of tracks of an artist may be dependent on the time spent by the user of the communication terminal in a given location with respect to the duration of this artists concert.

Optionally, the user command U_HGT provides an action ua making it possible not only to trigger the element determination ELT_DT but optionally to control it so as to obtain a more precise element.

In the case of a music festival, instead of searching only for the name of the artist in order to establish the playlist, the indication of favorite by the user will trigger the search for the track programmed at the instant of the user command so as to supplement the playlist with the track that the user was listening to during his user command U_HGT instead of tracks from the artist's hit list (for example, the 10 tracks most listened to).

Furthermore, the indication of favorite by the user will be able to trigger the search for the track programmed at the instant of the user command so as to supplement the playlist with the track that the user was listening to during his user command U_HGT in addition to one or more tracks from the artist's hit list (for example, the 10 tracks most listened to).

In particular, the method of user interface IUP comprises an access PLYLST_ACC to the personalized playlist relating to an event. This access PLYLST_ACC allows the user to request the playlist plylst_req from the communication terminal allowing the generation of playlists during the event or from another communication terminal allowing access either to the generator of playlists, or to a services provision device relating to the event, or to a device for providing contents 4 making available the playlist destined for the user for whom the playlist has been personalized (also dubbed the source user), and optionally for one or more other recipient users with whom the source user (for whom the playlist has been personalized) has shared his playlist.

In particular, the method of user interface IUP comprises a reproduction PLYLST_DSP of the personalized playlist relating to an event plylst. The playlist plylst is transmitted PLYLST_TR either in the course of generation, or subsequently on receipt of an access request plylst_req. The playlist plylst is transmitted PLYLST_TR by either the generator of playlists, or a services provision device relating to the event, or a device for providing contents 4 making available the playlist destined for the user for whom the playlist has been personalized (also dubbed the source user), and optionally for one or more other recipient users with whom the source user (for whom the playlist has been personalized) has shared his playlist.

In particular, the method of user interface IUP comprises a reading of the playlist PLYLST_RD which comprises particularly a reproduction Ci_RPR in the order of the playlist (as illustrated by FIG. 1: i=1, i+1) or in an order given by the user (sort on the name of the artist, sort by album, etc.) or in a random order of a or of a part or of the whole of the contents indicated in the playlist. This reproduction of a content Ci_RPR is particularly done on receipt of the content Ci provided by a content provision device 4 particularly on request Ci_req by a contents reading command PLYLST_(Ci) triggered by the reading of the playlist PLYLST_RD.

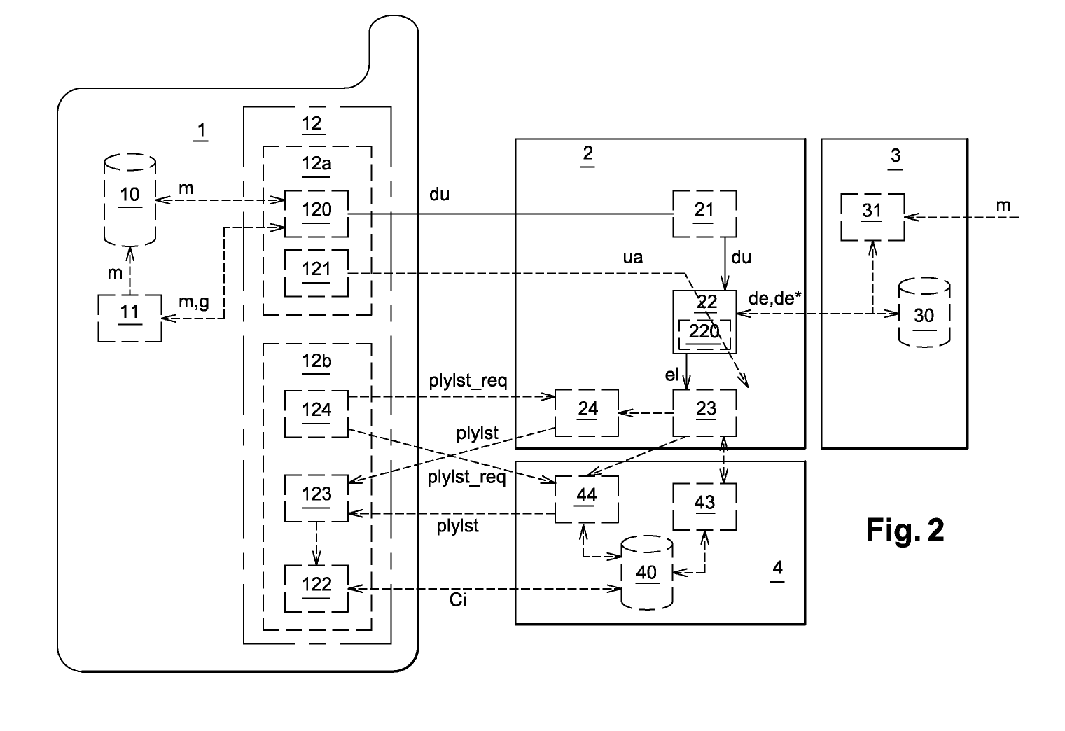

FIG. 2 illustrates a simplified diagram of an exemplary architecture comprising a generator of playlists and a user interface with said generator of playlists according to the invention.

A generator 2 of personalized playlists for reproducing contents in relation to the experience of an event by a user of a communication terminal 1, comprises an analyzer 22 able to determine at least two distinct elements el as a function of data provided du by said communication terminal 1 of said user and of data de relating to said event which are made available by a device for providing services 3 concerning said event. Each of said elements el makes it possible to determine at least one content c made available by at least one device for providing contents 4, said contents thus determined for each element being integrated into a playlist.

The analyzer 22 is particularly a contextual analysis engine making it possible to determine and store in real time the program which is the one attended by the user, in tandem with the event and with his perambulations over the venue of the event. This engine 22 takes as input for example the geolocation of the user in real time, via particularly a regular sounding (known as pooling) of the user's communication terminal 1 by the generator 2. This engine 22 compares particularly the data du originating from the communication terminal 1 with the geolocated programming de in a base, that is to say provided by a database of programs of a services provision device 3 relating to the event.

In particular, the playlists generator 2 comprises a receiver 21 of the data du transmitted by the communication terminal 1.

In particular, the playlists generator 2 comprises an integrator 24 into a playlist of at least one content as a function of an element el determined by said playlists generator 2.

Optionally, the generator 2 may trigger the reproduction by the communication terminal 1 of the element el or of the content c determined as a function of the element el (particularly the name of the program). Thus, the integrator 24 can be commanded by the communication terminal 1 (not illustrated) to integrate into the list the content c displayed so as to manually store in the playlist the name of the program. Alternatively, the integrator 24 automatically adds the content c determined into the playlist.

In particular, the playlists generator 2 comprises a contents search engine 23 able to determine from among the contents made available by at least one device for providing contents 4 at least one content as a function of an element el determined by said playlists generator 2.

A user interface 12,12a with a generator 2 of personalized playlists for reproducing contents in relation to the experience of an event by a user of a communication terminal comprises a trigger 120 for transmission of data du by said communication terminal 1 from said user to a playlists generator 2. The data du transmitted make it possible to determine an element el as a function of said data transmitted du by said communication terminal 1 of said user and of data de relating to said event which are made available by a device for providing services 3 concerning said event. The element el makes it possible to determine at least one content c made available by at least one device for providing contents 4.

In particular, the user interface 12 with a generator of playlists comprises at least one access 124 to at least one personalized playlist for reproducing contents in relation to the experience of said event by said user.

In particular, the user interface 12,12a with a playlists generator 2 comprises a user command device 121. The user command device 121 emits on action of the user of the communication terminal 1 a user action ua making it possible to trigger the analyzer 22 of the playlists generator 2.

The communication terminal 1 of a user comprises at least the user interface 12, 12a with a generator of personalized playlists for reproducing contents in relation to the experience of an event by a user of a communication terminal.

In particular, the communication terminal 1 comprises sensors 11, particularly a microphone and/or a camera, which provide captured audio and/or video data m either directly to the emitter (not illustrated) of the communication terminal or indirectly via the trigger 120 or after recording in a memory 10 of the communication terminal 1. These sensors 11 are particularly controlled by the trigger 120. The captured multimedia data m then constitutes at least part of the data du transmitted by the communication terminal 1 to the playlists generator 2.

The sensors 11 are optionally a location device, for example for location of GPS type, making it possible to provide location data g which constitutes at least part of the data du transmitted by the communication terminal 1 to the playlists generator 2.

In particular, the user interface 12 with a playlists generator 2 comprises a consultation interface 12b.

Particularly, the consultation interface 12b or directly the user interface 12 with a generator of playlists comprises an engine 124 making it possible to request access to a playlist either directly from a playlist generator 2, or from a content provision device 4.

In particular, the consultation interface 12b or directly the user interface 12 with a generator of playlists comprises a playlists reader 123 receiving the playlist generated by the playlists generator 2. The playlist is received from the generator 2 or from the content provision device 4 or from the device for providing services that are linked with the event 3, etc.

In particular, the consultation interface 12b or directly the user interface 12 with a generator of playlists comprises a reproducer 122 of one or more of the contents of playlists. The reproducer 122 requests from a content provision device 3 the contents of the lists to be reproduced (particularly selected by the user from the playlist) for example by means of the link or of other elements el* indicated for the content ci in the playlist. The link is particularly an address at which the content ci is stored in a memory or in a database of contents 40 of the content provision device 4.

In particular, the services provision device 3 relating to the event comprises a memory 30 making it possible to store the program of the event particularly in the form of a database indicating, for example, for each artist and/or work, a start instant, an end instant, and/or a location zone (location zone being intended to mean a rectangular zone defined by at least three points given by GPS coordinates, or a cellular zone defined by at least one point given by GPS coordinates and a radius of given size), etc.

In particular, the services provision device 3 relating to the event comprises an emitter of data de relating to an event, particularly all or part of the data stored in a memory of said services provision device 3 relating to the event as a function particularly of the instant of emission. For example, only the data de of the works in progress (live) are emitted by the services provision device 3. The services provision device 3 emitter is, optionally, activated on request of the playlists generator 2 which provides particularly the location of the communication terminal 1 so as to reduce the data de emitted by the device for providing services 3 to those corresponding to this location, or indeed to this location at the instant at which the location was captured or determined.

In particular, the services provision device 3 relating to the event comprises a receiver of multimedia captured data m originating from at least one sensor (not illustrated in the figure). The sensor comprises particularly a microphone placed on a stage of a music festival, or recording means connected to an audio and/or video and/or image output of the mixing table of a stage of a music festival, etc. The captured multimedia data m are transmitted to the services provision device 3 relating to the event via a wired or non-wired local or remote communication network. The device for providing services 3 comprises a real-time generator of data relating to the event 31, such as either a device for real-time recognition of the captured multimedia data received as a function of data de relating to the event that are stored in the device for providing services 3, or a requester able to request a recognition of the captured multimedia data received at a recognition device and to receive the resulting data from this recognition device, etc.

Thus, the device for providing services 3 can provide the playlists generator 2 not only with data de relating to the event that are stored in the device for providing services 3, but also with data de* relating to the event that were generated in real time by the device for providing services 3 as a function of captured multimedia data m originating from a sensor connected to the device for providing services via a communication network.

For example, the services provision device 3 relating to a music festival comprises a database in which is recorded prior to the event the programming of the latter: such as, for each stage, the artist and the programming time period (optionally the geolocation coordinates for the stage or its geographical address etc.) The mixing tables of each stage return multimedia data m in real time to the device for providing services 3, for example the audio data. The device for providing services 3 recognizes by virtue of a device for recognition of the device for providing services 3, or remotely the name of each track played on each of the stages in real time. Thus, the data de relating to the event provided by the device for providing services 3 will comprise not only previously stored data de relating to the event, such as the artists playing on each of the stages at the instant of dispatch of the data de relating to the event, but also real-time data de* relating to the event such as the name of each track recognized as being played on each of these stages at the instant of dispatch of the data de* relating to the event.

Another example, a captured multimedia datum such as a photograph, will make it possible particularly to recognize an artist invited on the stage by a programmed artist so as to integrate into the playlist, optionally, a track in which the two artists sing a duet.

In an alternative manner (not illustrated) to the architecture of the figure, the generator 2 of content playlists is integrated into a services provision device relating to the event 3.

In particular, the device for providing contents 4 comprises a database of contents 40 from which are determined the contents integrated into the playlist generated by the playlists generator 2. Particularly, a contents search engine 23 of the playlists generator 2 and/or 43 of the device for providing contents 4 determines(determine) from among the contents made available in the database of contents 40 by the device for providing contents 4 at least one content as a function of an element el determined by said playlists generator 2.

In particular, the device for providing contents 4 comprises an integrator 44 into a playlist receiving the elements to be integrated from the playlists generator 2. Said integrator 44 can provide the playlist to a user interface 12, 12b of a communication terminal, in particular on request of this user interface 12, 12b.

In an alternative, not illustrated, the device for providing contents 4 comprises a database of contents 40 and the generator of playlists for reproducing contents 2.

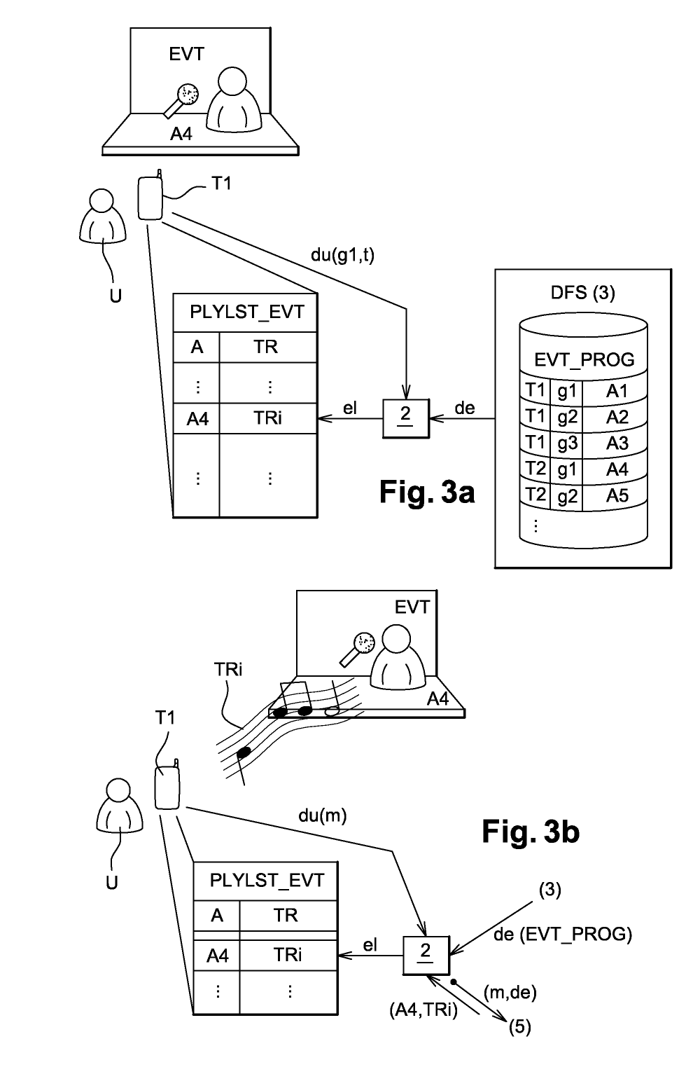

FIGS. 3a and 3b illustrate two simplified diagrams of two examples of variants of implementation of the invention.

FIG. 3a illustrates the integration of a content into a playlist as a function of location data.

The user U carrying a communication terminal T1 attends, during an event EVT such as a music festival, a concert of an artist A4. Since the user U has subscribed to a service of personalized playlist generation relating to the experience of events, his communication terminal T1 transmits data du to a playlists generator 2 either automatically, or on request of the playlists generator 2.

In particular, the communication terminal T1, particularly its user interface with the playlists generator 2, can emit during the period of the event data du either periodically and/or as a function of the user's movements and/or on action of the user, or on request of the generator 2.

The use of the knowledge of the user's movements makes it possible to reduce the periodicity when the user moves and to lengthen it when the user has remained at the same location, thus making it possible to reduce the data du transmitted when the user U attends the same concert from the start to the end, while making it possible to determine that he attends the following concert on the same stage.

The limitation to the emission on action of the user makes it possible to reduce not only the data du to the experience of the user that aroused an interest, but also the contents of the playlists.

The limitation to the emission on request of the generator allows only the data du: since the generator 2 has knowledge of the program of the event by virtue of the data de provided by the device for providing services relating to the event DFS (3), the generator 2 can request the data du of the user at predetermined instants around the instants of start and/or end of works during the event.

The program of the event EVT_PROG is particularly recorded in a database of the services provision device DFS (3) relating to the event. For example, it is recorded that:
in the period T1, in the location zone g1, artist A1 is playing;
in the period T1, in the location zone g2, artist A2 is playing;
in the period T1, in the location zone g3, artist A3 is playing;
in the period T2, in the location zone g1, artist A4 is playing;
in the period T2, in the location zone g2, artist A5 is playing;
in the period T2, in the location zone g3, artist A6 is playing, etc.

Thus, in our example, the data du indicates that the user U was present at the location g2 at the instant t. The playlists generator 2 determines that the instant t lies in the period T2, and therefore the element el determined by the playlists generator 2 as a function of the data du of the communication terminal T1 and of the data relating to the event comprises the artist A4.

Thus, the event-related personalized playlist PLYLST_EVT generated by the playlist generator 2 comprises a track TRi by the artist A4, for example a track indicated in the program EVT_PROG provided by the services provision device DFS (3) relating to the event or a track from the artists hit list (lists of the artists N most listened to tracks).

FIG. 3n illustrates the integration of a content into a playlist as a function of captured multimedia data.

The user U carrying a communication terminal T1 attends a concert by an artist A4 during an event EVT such as a music festival. The user U, having subscribed to a service of personalized playlist generation relating to the experience of events, captures by means of his communication terminal T1 the track played by the artist A4 and transmits it in the form of data du, thus comprising at least the captured multimedia data m, to a playlists generator 2.

The playlists generator 2 dispatches to a recognition device 5 (optionally integrated into the generator 2, not illustrated in FIG. 3b) the captured multimedia data m and optionally other data dependent on the data relating to the event de and optionally other data du received from the communication terminal T1. Thus, the recognition is performed on a number of tracks which is limited by these data de, du, for example on the tracks of the artists programmed for the event, or better on the tracks of the artists programmed over the capture time span and/or the location of capture.

The recognition device transmits at least one element el as a function of the recognition results such as the name of the artist A4, and the name of the track TRi.

Thus, the event-related personalized playlist PLYLST_EVT generated by the playlist generator 2 comprises a recognized track TRi by the artist A4.

The invention can, furthermore, be applied to trade fairs, thus the movement of the visitor around the trade fair makes it possible to determine as a function of data relating to the event (such as the demonstration area and programming, the position of each exhibitor's stands, etc.) contents such as business cards, video of the exhibitor and/or of the demonstration, first page of an Internet site associated with the exhibitor. The visitor can thus subsequently re-experience his visit by virtue of the playlist personalized as a function of his experience of the trade fair: either by reading this playlist which displays, particularly, in the form of a slideshow, the various contents constituting it, or by accessing more specifically a content of this playlist.

Another application of the invention is the creation of a playlist for reproduction as a function of the experience of a visit of a town, of a museum, of an exhibition etc. In the same manner as for the trade fair, the downloaded contents may be diverse: text, photos, videos etc. and the playlist proposed makes it possible either to scroll through either in the form of a video and/or audio montage, in the form of a slideshow, the various contents placed in this list so as to re-experience this visit, or to directly access the reproduction of a content of this list in particular.

The invention is also aimed at a medium. The information medium can be any entity or device capable of storing at least one of the programs according to the invention. For example, the medium can comprise a storage means, such as a ROM, for example a CD ROM or a microelectronic circuit ROM or else a magnetic recording means, for example a diskette or a hard disk.

Moreover, the information medium can be a transmissible medium such as an electrical or optical signal which can be conveyed via an electrical or optical cable, by radio or by other means. The program according to the invention can be in particular downloaded from a network particularly of Internet type.

Alternatively, the information medium can be an integrated circuit into which the program is incorporated, the circuit being adapted for executing or to be used in the execution of the method in question.

In another deployment, the invention is implemented by means of software components and/or hardware components. In this regard the term module may correspond equally well to a software component or to a hardware component. A software component corresponds to one or more computer programs, one or more sub-programs of a program, or more generally to any element of a program or of an item of software able to implement a function or a function set according to the description hereinbelow. A hardware component corresponds to any element of a hardware set able to implement a function or a set of functions.

Although the present disclosure has been described with reference to one or more examples, workers skilled in the art will recognize that changes may be made in form and detail without departing from the scope of the disclosure and/or the appended claims.

1. A method comprising:
generating with a generator device personalized playlists for reproducing contents in relation to an experience of an event by a user of a communication terminal, wherein generating comprises:
determining with the generator device at least two distinct elements as a function of data received by the generator device from said communication terminal of said user and of data relating to said event received by the generator device from a device for providing services concerning said event, each of said elements being configured to enable determination of at least one content made available by at least one device for providing contents, and
integrating said at least one content thus determined for each element into a playlist.

2. The method according to claim 1, wherein integrating comprises integrating said at least one content into a playlist relating to the experience of the event by the user, said at least one content being determined as a function of said element.

3. The method according to claim 1, wherein the method comprises a recovering of geolocation data constituting at least one datum provided by said communication terminal of said user.

4. The method according to claim 1, wherein the method comprises recovering multimedia data captured by said communication terminal constituting at least one datum provided by said communication terminal of said user.

5. The method according to claim 1, wherein the method comprises triggering said determination of an element on an action of said user on said communication terminal.

6. A non-transmissible information medium comprising a program incorporated or stored thereon and having program code instructions for execution of a method of generating playlists when said program is executed by a processor, wherein the method comprises:
generating with the processor personalized playlists for reproducing contents in relation to an experience of an event by a user of a communication terminal, wherein generating comprises:
determining with the processor at least two distinct elements as a function of data provided by said communication terminal of said user and of data relating to said event which are made available by a device for providing services concerning said event, each of said elements being configured to enable determination of at least one content made available by at least one device for providing contents, and
integrating with the processor said at least one content thus determined for each element into a playlist.

7. A generator of personalized playlists for reproducing contents in relation to an experience of an event by a user of a communication terminal, said generator of playlists comprising:
an analyzer configured to determine at least two distinct elements as a function of data provided by said communication terminal of said user and of data relating to said event which are made available by a device for providing services concerning said event, each of said elements being configured to enable the analyzer to determine at least one content made available by at least one device for providing contents, the generator further being configured to integrate said contents thus determined for each element into a playlist.

8. A device for providing contents comprising:
a database of contents stored in a non-transmissible information storage medium; and
a generator of playlists configured to reproduce contents, said generator of playlists comprising an analyzer configured to determine at least two distinct elements as a function of data provided by a communication terminal of a user and of data relating to an event experienced by said user and which are made available by a device for providing services concerning said event, each of said elements being configured to enable the analyzer to determine at least one content made available by said device for providing contents, the generator further being configured to integrate said contents thus determined for each element into a playlist.

9. A device for providing services relating to an event, the device for providing services being configured to make available to a generator of personalized playlists for reproducing contents in relation to an experience of an event by a user of a communication terminal, data relating to said event, as a function of which contents and of data provided by said terminal of said user, wherein the generator of playlists determines an element making it possible to determine at least one content made available by at least one device for providing contents.

10. The device for providing services according to claim 9, wherein the device for providing services comprises a real-time generator of data relating to said event as a function of captured multimedia data received by the device for providing services.

11. (canceled)

12. (canceled)

13. (canceled)

14. (canceled)

15. A communication terminal of a user comprising:
at least one user interface configured to interface with a generator of personalized playlists for reproducing contents in relation to an experience of an event by a user of a communication terminal, said user interface device comprising a trigger for transmission of data by said communication terminal from said user to the generator of playlists, said transmitted data being configured to enable the generator to determine at least two elements as a function of said data transmitted by said communication terminal of said user and of data relating to said event which are made available by a device for providing services concerning said event, each of said elements being configured enable the generator to determine at least one content made available by at least one device for providing contents, said contents thus determined for each element being integrated into a playlist.
